(19) United States
(12) Patent Application Publication
(10) Pub. No.: US 2007/0071916 A1
(43) Pub. Date: Mar. 29, 2007

(54) Decorative ball

(76) Inventor: Chang Lin Chun, Taichung City (TW)

Correspondence Address: CHARLES E. BAXLEY, ESQ., 90 JOHN STREET, THIRD FLOOR, NEW YORK, NY, 10038, US

(21) Appl. No.: 11/235,007

(22) Filed: Sep. 26, 2005

(51) Int. Cl. G09F 19/00; B31D 3/02

(52) U.S. Cl. 428/11; 428/12

(57) ABSTRACT

A decorative ball comprises: a base, an inserting member, and a posting member. The base is made of flexible material and has a plurality of supporting pieces arranged in radial manner. The inserting member has an end positioned at a center of the base and having another end positioned at an end of the respective supporting pieces, after the ends of the supporting pieces are piled up, the base can form a ball structure. And the positioning member positioned on the inserting member and located at the end of the respective supporting pieces.

### BACKGROUND OF THE INVENTION

1. Field of the Invention

The present invention relates to a decorative product, and more particularly to a decorative ball.

2. Description of the Prior Art

Decorative ball is usually used to create a happy festival atmosphere during holiday, and conventional decorative ball generally includes two types of structure: the ball with smooth surface and the ball with honeycomb-shaped surface.

The decorative ball with smooth surface is normally a hollow plastic ball whose surface is printed or coated with a single colored pattern. Therefore, this kind of decorative ball is boring and dull in appearance.

The decorative ball with honeycomb-shaped surface is only changeable in the color of its surface or of its honeycomb, and accordingly, this decorative ball is also boring and dull in appearance.

The present invention has arisen to mitigate and/or obviate the afore-described disadvantages.

### SUMMARY OF THE INVENTION

The primary objective of the present invention is to provide a decorative ball, wherein a plurality of supporting pieces of a base of the decorative ball are spaced apart from one another and arranged in a radial manner, forming a hollow out decorative ball. Furthermore, both sides of the respective supporting pieces are formed in the shape of a continuous wave, therefore, the shape of the decorative ball in accordance with the present invention is distinct over the conventional decorative ball. And the decorative ball in accordance with the present invention can be unfolded for easy transportation.

A decorative ball in accordance with the present invention comprises:

a base made of flexible material and having a plurality of supporting pieces arranged in radial manner;

an inserting member having an end positioned at a center of the base and having another end positioned at an end of the respective supporting pieces, after the ends of the supporting pieces are piled up, the base can form a ball structure; and

a positioning member positioned on the inserting member and located at the end of the respective supporting pieces.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a decorative ball in accordance with a first preferred embodiment of the present invention;

FIG. 2 is a perspective view of the decorative ball in accordance with the first preferred embodiment of the present invention;

FIG. 3 is an assembly perspective view of the decorative ball in accordance with the first preferred embodiment of the present invention;

FIG. 4 is an exploded view of a decorative ball in accordance with a second preferred embodiment of the present invention;

FIG. 5 is an exploded view of a decorative ball in accordance with a third preferred embodiment of the present invention;

FIG. 6 is a perspective view of a decorative ball in accordance with a third preferred embodiment of the present invention;

FIG. 7 is an exploded view of a decorative ball in accordance with a fourth preferred embodiment of the present invention;

FIG. 8 shows the inserting member in accordance with the fourth preferred embodiment of the present invention; and

FIG. 9 shows another type of base of the decorative ball in accordance with the present invention.

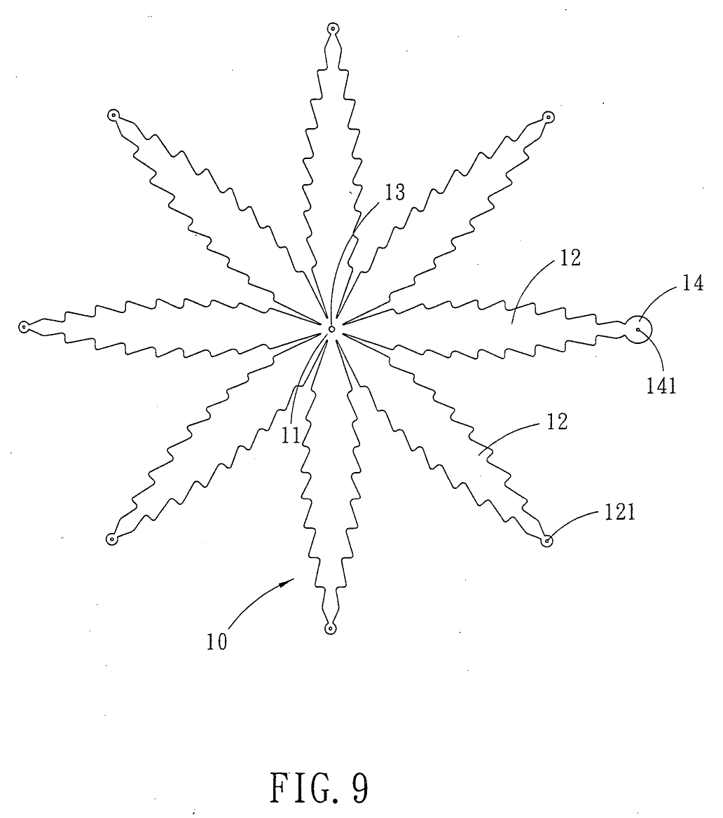

### DETAILED DESCRIPTION OF THE PREFERRED EMBODIMENTS

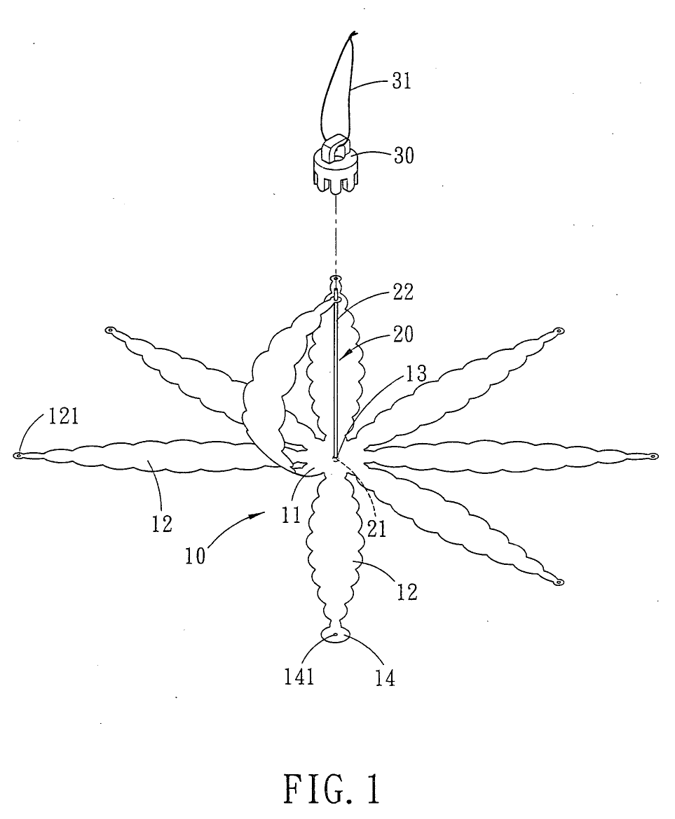

Referring to FIG. 1, a decorative ball in accordance with a first preferred embodiment of the present invention is shown and comprises a base 10, an inserting member 20 and a positioning member 30.

The base 10 is made of flexible material, such as plastic material, and includes a connecting portion 11 and a plurality of supporting pieces 12. The connecting portion 11 is centrally defined with a central hole 13, the supporting pieces 12 are integrally formed with the periphery of the connecting portion 11 and are arranged in a radial manner. Both sides of the respective supporting pieces 12 are formed in the shape of a continuous wave. One of the supporting pieces 12 has a limiting end 14 in which being formed a through hole 141, and in the end of the rest supporting pieces 12 is formed a through hole 121.

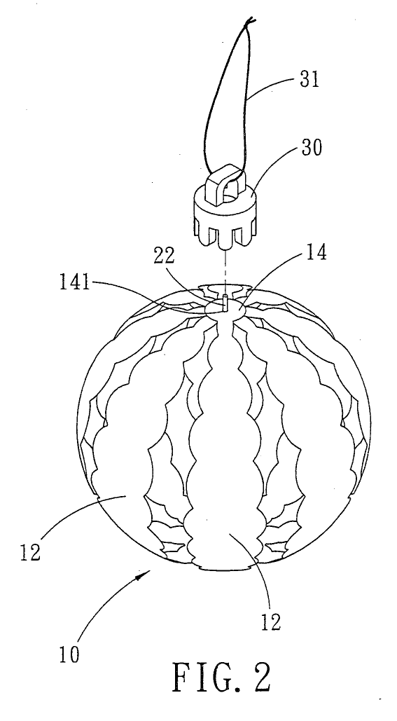

The inserting member 20 is made of flexible material, such as nylon thread, and has a fixing end 21 and a free end 22. The fixing end 21 is fixed at the outer edge of the central hole 13 of the base 10 after the free end 22 passes through the central hole 13, and then the free end 22 will pass through the through holes 121 of the respective supporting pieces 12 and finally pass through the through hole 141 in the limiting end 14 of the supporting piece 12. The respective supporting pieces 12 are folded together to form a decorative ball, and the limiting end 14 is positioned on the top, as shown in FIG. 2, so that the base is a hollow structure.

A positioning member 30 is a shell structure glued being assembled with the free end 22 of the inserting member 20 and located on the limiting end 14 of the base 10. A hanging rope 31 is inserted through the positioning member 30.

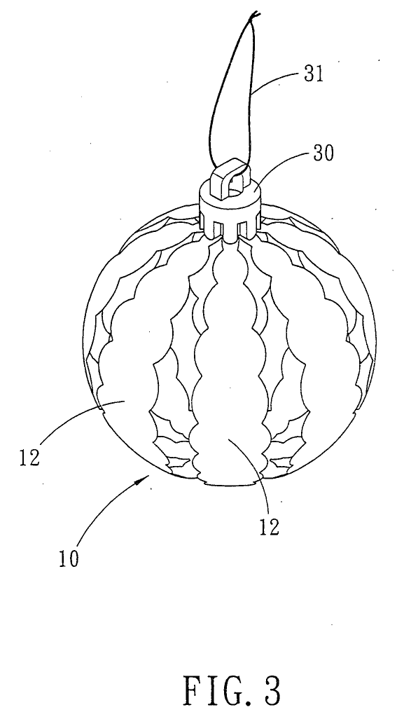

For a better understanding of the present invention, reference should be made to FIGS. 1-3, the fixing end 21 will be fixed at the outer edge of the central hole 13 of the base 10 after the free end 22 passes through the central hole 13.

After that, the user can fold the respective supporting pieces 12 upward to engage the through holes 13 in the free end 22 of the inserting member 20 respectively, and then, the through hole 141 of the limiting end 14 is provided for insertion of the free end 22 of the inserting member 20.

Finally, the positioning member 30 is glued to the limiting end 14 of the base 10 and the limiting end 22 of the inserting member 20.

The supporting pieces 12 are spaced apart from one another and arranged in a radial manner, forming a hollow out decorative ball. Furthermore, both sides of the respective supporting pieces 12 are formed in the shape of a continuous wave, therefore, the shape of the decorative ball in accordance with the present invention is distinct over the conventional decorative ball. And the decorative ball in accordance with the present invention can be unfolded for easy transportation.

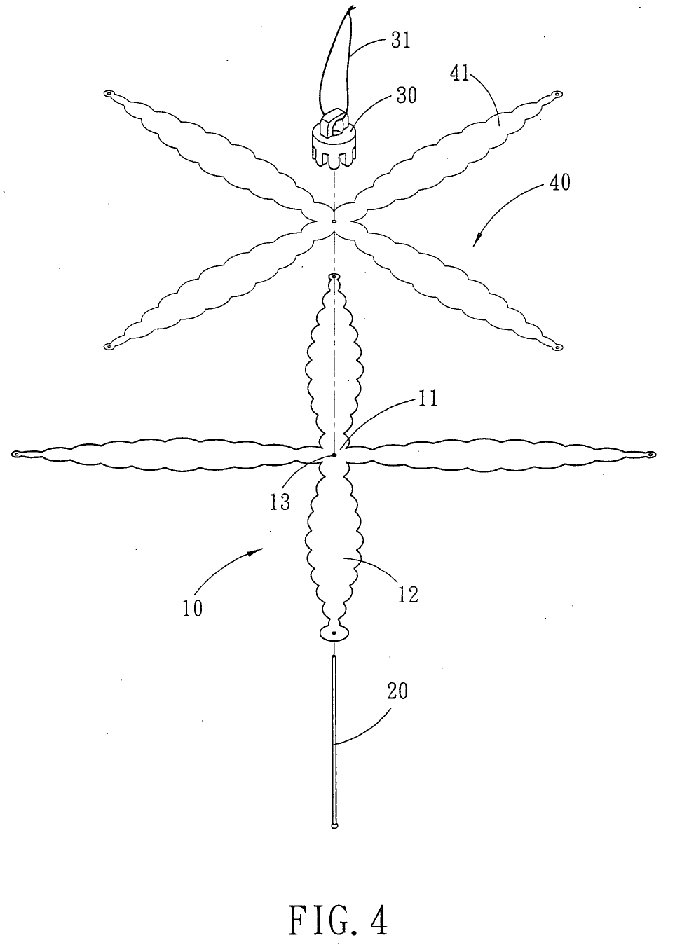

Referring to FIG. 4, a decorative ball in accordance with a second preferred embodiment of the present invention is identical to the first preferred embodiment, except that it comprises two bases 10 and 40, and the supporting pieces 12 and 41 of the two bases 10 and 40 are arranged alternatively.

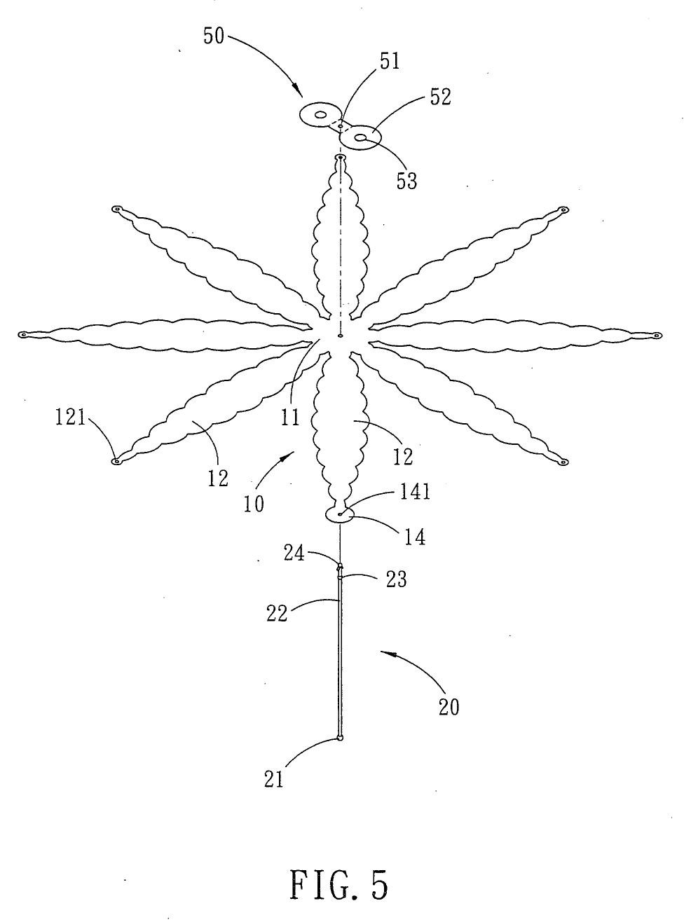

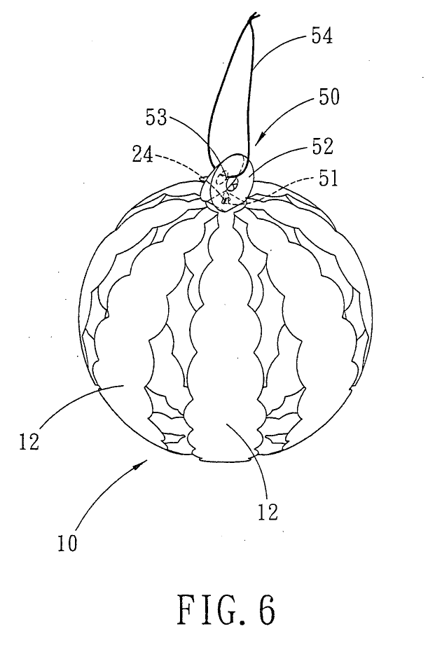

Referring to FIGS. 5 and 6, a decorative ball in accordance with a third preferred embodiment of the present invention is identical to the first preferred embodiment, except that:

The inserting member 20 has a fixing end 21 and a free end 22. At the fixing end 21 are formed with an annular stop portion 23 and a slant column-like anti-disengagement protrusion 24, respectively. The anti-disengagement protrusion 24 slants toward the fixing end 21. The through hole 121 of the respective supporting pieces 12 of the base 10 is provided for insertion of the free end 22 of the inserting member 20 and are confined between the annular stop portion 23 and the anti-disengagement protrusion 24.

The positioning member 50 is a laminar structure being centrally formed with a hole 51 and has two folding portions 52. Each of the folding portions 52 is defined with an aperture 53. The anti-disengagement protrusion 24 of the inserting member 20 is inserted through the hole 51 of the positioning member 50, and then a hanging rope 54 is inserted through the aperture 53 of the folding portions 52. In this way, a hollow out decorative ball is formed.

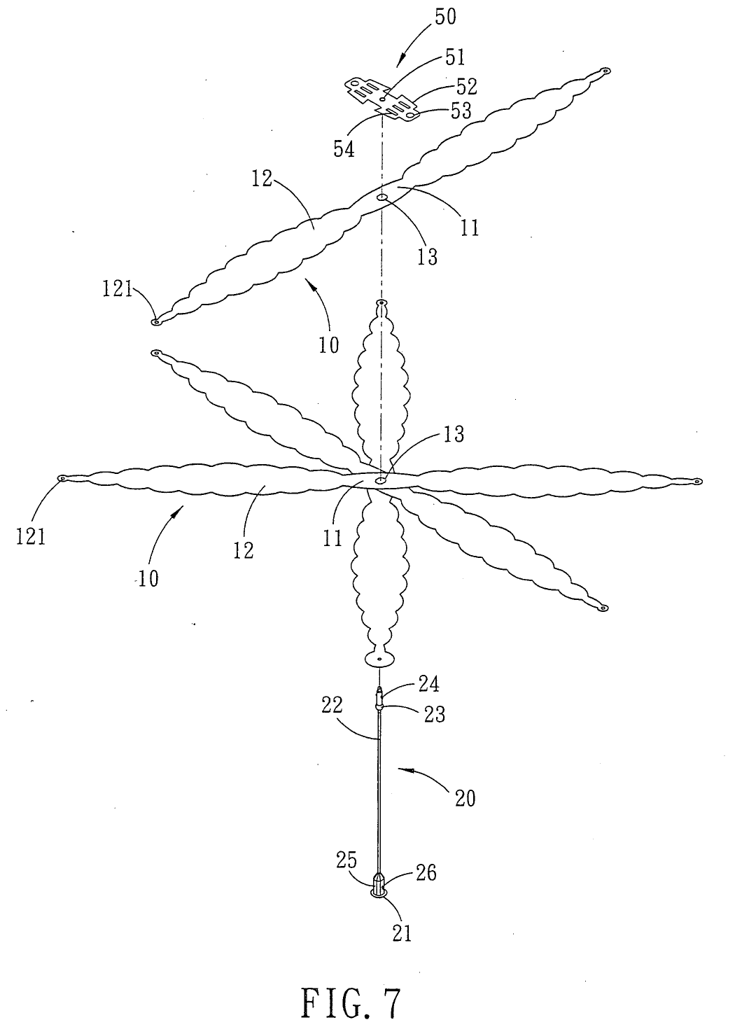

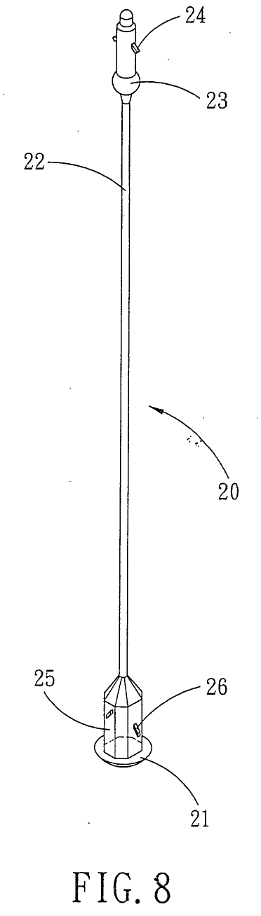

Referring to FIGS. 7 and 8, a decorative ball in accordance with a third preferred embodiment of the present invention is identical to the third preferred embodiment, except that:

The decorative ball in this embodiment comprises four bases 10, and the supporting pieces 12 of the respective bases 10 are arranged alternatively. The hole 13 of the respective bases 10 is octagonal, at the fixing end 21 of the inserting member 20 is formed a locking portion 25 having a octagonal shape, and on the outer surface of the locking portion 25 are formed a pair of symmetrical slant column-like anti-disengagement protrusions 26 that slant toward the fixing end 21. At the free end 22 of the inserting member 20 are formed an annular stop portion 23 and a slant column-like anti-disengagement protrusion 24. The positioning member 50 is a laminar structure being centrally formed with a hole 51 and has two folding portions 52. Each of the folding portions 52 is defined with an aperture 53 and a plurality of decorative holes 54.

The central hole 13 of the bases 10 is engaged with the locking portion 25 of the inserting member 20 and is confined between the fixing end 21 and the anti-disengagement protrusions 26, so as to prevent the respective bases 10 from rotating relative to the inserting member 20. The hole 121 of the respective supporting pieces 12 is engaged in the free end 22 of the inserting member 20 and is confined between the annular stop portion 23 and the anti-disengagement protrusion 24. The hole 51 of the positioning member 50 is provided for insertion of the anti-disengagement portion 24 of the inserting member 20.

It will be noted that both sides of the respective supporting pieces 12 also can be serrated.

While we have shown and described various embodiments in accordance with the present invention, it should be clear to those skilled in the art that further embodiments may be made without departing from the scope of the present invention.

What is claimed is:

1. A decorative ball comprising:
a base made of flexible material and having a plurality of supporting pieces arranged in radial manner;
an inserting member having an end positioned at a center of the base and having another end positioned at an end of the respective supporting pieces, after the ends of the supporting pieces are piled up one another, the base can form a ball structure; and
a positioning member positioned on the inserting member and located at the end of the respective supporting pieces.

2. The decorative ball as claimed in claim 1, wherein both sides of the respective supporting pieces are formed in the shape of a continuous wave.

3. The decorative ball as claimed in claim 1, wherein both sides of the respective supporting pieces are serrated.

4. The decorative ball as claimed in claim 1 further comprising a plurality of bases that are piled up, and the supporting pieces of the respective bases are arranged alternatively.

5. The decorative ball as claimed in claim 1, wherein the base includes a connecting portion and the plurality of supporting pieces, the connecting portion is centrally defined with a central hole, the supporting pieces are integrally formed with a periphery of the connecting portion, in the end of the supporting pieces is formed a through hole, an end of the inserting member is inserted in the central hole of base, and another end of the inserting member is inserted in the through hole of the respective supporting pieces.

6. The decorative ball as claimed in claim 1, wherein the positioning member is a shell structure and is connected with a hanging rope.

7. The decorative ball as claimed in claim 5, wherein one of the supporting pieces of the base has a limiting end in which being formed a through hole, and the supporting pieces having the limiting end is positioned on the utmost top position after the ends of the rest supporting pieces are folded and piled up one another.

8. The decorative ball as claimed in claim 5, wherein the inserting member has a fixing end, the inserting member is inserted in the central hole of the base and the fixing end will be fixed at an outer edge of the central hole of the base.

9. The decorative ball as claimed in claim 5, wherein the inserting member is formed with a stop portion and a slant column-like anti-disengagement protrusion, respectively, the anti-disengagement protrusion slants toward the fixing end of the inserting member, the respective supporting pieces of the base are confined between the annular stop portion and the anti-disengagement protrusion.

10. The decorative ball as claimed in claim 5, wherein an octagonal locking portion formed at the fixing end of the inserting member, and on an outer surface of the locking portion are formed a column-like anti-disengagement protrusion that slants toward the fixing end, and the central hole of the base is octagonal for engaging with the locking portion of the inserting member and is confined between the fixing end and the anti-disengagement protrusion of the inserting member.

11. The decorative ball as claimed in claim 9, wherein the positioning member is a laminar structure being centrally formed with a hole for insertion of the anti-disengagement protrusion of the inserting member and has two folding portions, each of the folding portions is defined with an aperture, and a hanging rope is inserted through the aperture of the folding portions.
